(19) United States
(12) Patent Application Publication
(10) Pub. No.: US 2005/0243400 A1
(43) Pub. Date: Nov. 3, 2005

(54) Multifunctional housing

(75) Inventors: Christoph Brabec, Linz (AT); Herbert Schewe, Herzogenaurach (DE)

Correspondence Address: YOUNG & THOMPSON, 745 SOUTH 23RD STREET, 2ND FLOOR, ARLINGTON, VA, 22202, US

(73) Assignee: Siemens Aktiengesellschaft, Munchen (DE)

(21) Appl. No.: 10/526,970

(22) PCT Filed: Sep. 4, 2003
(86) PCT No.: PCT/DE03/02942

§ 371 Date: Mar. 7, 2005

(30) Foreign Application Priority Data
Sep. 5, 2002 (DE) 10241206.5

(51) Int. Cl. G02F 1/15

(52) U.S. Cl. 359/265

(57) ABSTRACT

The invention relates to a multifunctional housing for so-called white/grey goods, in particular an electrical domestic appliance, a consumer electronic product, including mobile devices such as mobile telephones etc and/or a bulky device, for example from the medical, power generating plant, or the automobile sphere. The optional colours are already an improvement over existing possibilites, but in particular, the combinations made possible by the inclusion of various sensors and/or energy supplies such as solar cells are particularly advantageous.

The invention relates to a housing for so-called white/grey goods, in particular an electrical domestic appliance, a consumer electronic product, including mobile devices such as mobile telephones etc. and/or a bulky device, for example from the medical, power generation or automotive fields.

Housings are known, which can be interchanged so that the color effect of the housing can be changed for example, and the requirements of the owner can be matched. The disadvantage of this is that the housings only ever show one color and otherwise fulfill no other function.

There is however a need to create housings, the color of which changes as required and/or which are functional.

The object of the invention is therefore to create a housing, which can fulfill several functions and shows color changes without exchanging fixed parts.

The present invention relates to a housing, which comprises a solid base element, which is coated with a film at least in sub-areas, the film serving as a substrate on which at least one electronic component is arranged.

According to one embodiment, the electronic component is an electrochemical cell, the doping of the dye causing a change in the color of the electrochemical component. Generally the structure of an electrochemical cell is used, which comprises an electrode, the respective electrochromic dye, the electrolytes and a counter-electrode. Encapsulation between the two electrodes is expedient in order to avoid electrolyte loss. Doping of the electrochromic dye takes place by applying a voltage which causes the electrolyte ions to be diffused into the dye, thereby oxidizing or reducing it. If a housing is coated with this type of electrochromic film, the color of the housing can change by applying a low voltage. The color change is preferably reversible.

According to a further embodiment, an electronic component is a photovoltaic cell, a solar cell for instance. In particular, the application of organic solar cells or at least solar cells predominantly constructed from organic material is of interest, as the solar cells supply sufficient electrical power to switch the electrochromic colors, even with weak ambient lighting.

According to another embodiment, an electronic component is a photodetector for example, which can detect the ambient light (intensity and/or color) and switches the color of the film and thus the coated part of the housing depending on ambient conditions.

According to further embodiments, different electronic components comprising different sensor technologies can be arranged on the film. Gas sensors, temperature sensors, moisture sensors and/or other sensors can thus be used to supply information regarding different ambient conditions via the housing. In future it will thus be possible to read the current environmental situation of the housing from the housing itself. This applies in particular to radiation (UV, X-ray, and radioactivity) and/or air (ozone) and/or other loads which can be detected by means of sensors.

The following compounds can be given as examples of electrochromic color systems which can be used; polyaniline (PANI), PEDOT or derivatives thereof, viologene or further conjugated polymer or molecular color systems, which can change their color status with oxidization or reduction.

The solid base element of the housing is made from plastics, which have hitherto generally been used for housings of this type, such as PVC, PE, etc.

In this case, the term ‘housing’, does not just refer to elements known traditionally as housings, but also refers to clothing items and/or parts of motor vehicles or the like. Preferred housings are those of telephones, in particular mobile telephones, Walkman devices and also helmets, sheet-metal bicycle parts and automobile chassis etc.

The film which serves as a substrate for the electronic component is preferably a flexible film such as PET, PMMA, PC, and polyimide for example.

The electronic components are preferably those which are constructed predominantly from organic material, the term ‘organic material’ or ‘functional polymer’ or ‘polymer’ here comprising all types of organic, organometallic and/or organic-inorganic plastics (hybrids), generally referred to as ‘plastics’. These are all types of materials except for semiconductors, which form the conventional diodes (germanium, silicon) and the typical metallic conductor. There is therefore no restriction in the dogmatic sense to organic material as a material containing carbon, rather the wide use of silicones for example is also considered. Furthermore, the term should not be subject to any restriction with regard to molecule size, in particular to polymer and/or oligomer materials, but the use of small ‘molecules’ is by all means also possible. The ‘polymer’ part of the word in ‘functional polymer’, is historic and therefore does not indicate the presence of an actual polymer compound.

Functional polymers can refer to semi-conductive, conductive and/or insulating materials.

Electronic components formed predominantly from organic material are characterized in that as a rule they can be arranged on flexible substrates. The individual functional layers such as conductor, semi conductor, insulator, emitting layer, photovoltaically active layer etc. are thus made from predominantly organic material. The solubility of the organic material often allows these components to be manufactured by means of printing and/or using a simple roll to roll method.

The invention firstly allows a housing to be incorporated into the functionality of the device, in other words an economic value added can be created by means of the design and effect of the housing. The changeable color of the housing alone is already an improvement, but in particular the combinations made possible by the inclusion of various sensors and/or energy sources such as solar cells are particularly advantageous.

1. Housing comprising a solid base element and coated with a film in at least sub-areas, the film serving as a substrate on which at least one electronic component is arranged.

2. Housing according to claim 1, wherein the at least one electronic component has an electrochromic color system.

3. Housing according to claim 2, wherein the electrochromic color system causes a reversible change in the housing color.

4. Housing according to claim 1, wherein the at least one electronic component has a photovoltaic cell.

5. Housing according to claim 1, wherein the at least one electronic component has a sensor.

6. Housing according to claim 1, wherein the at least one electronic component is predominantly constructed from organic material.

7. Housing according to claim 4, wherein the photovoltaic cell is a solar cell.

8. Housing according to claim 1, wherein the at least one electronic component is a photodetector.
